(19) United States
(12) Patent Application Publication
(10) Pub. No.: US 2007/0017388 A1
(43) Pub. Date: Jan. 25, 2007

(54) Humidity maintenance and deodorization structure for Kimchi storage having cooling air circulation fan

(75) Inventors: Young Gil Lee, Asan-City (KR); Hae Sung Kim, Asan-City (KR)

Correspondence Address: FITZPATRICK CELLA HARPER & SCINTO, 30 ROCKEFELLER PLAZA, NEW YORK, NY, 10112, US

(73) Assignee: WINIA MANDO INC., Asan-city (KR)

(21) Appl. No.: 11/486,253

(22) Filed: Jul. 14, 2006

(30) Foreign Application Priority Data
Jul. 15, 2005 (KR) 2005-64034

(51) Int. Cl. A01J 11/04

(52) U.S. Cl. 99/467

(57) ABSTRACT

A humidity maintenance and deodorization structure for a Kimchi storage includes a cooling air circulating fan which is mounted in a fan mounting portion provided on the bottom of a door which opens and closes a storage room or chamber in the Kimchi storage. A deodorizing agent receiving portion is formed in the bottom of the door to receive a deodorizing agent at the one side of the fan mounting portion. In the Kimchi storage, an air flow path is formed between the fan mounting portion and the deodorizing agent receiving portion. A constant humidity agent is disposed along the flow path of the cooling air circulating fan and moreover a constant humidity agent cover which supports and receives the constant humidity agent is mounted while covering the fan mounting portion. The deodorizing agent is arranged in the deodorizing agent receiving portion which is at the discharge end of the flow path of the cooling air from the circulating fan, and moreover a deodorizing agent cover which supports and receives the deodorizing agent is mounted while covering the deodorizing agent receiving portion. Accordingly, the air in the storage chamber is forcibly circulated by the operation of the cooling air circulating fan in which the air is inhaled toward the constant humidity agent and discharged through the cooling air circulating fan and the deodorizing agent in sequence. Likewise, the deodorizing agent is arranged together with the constant humidity agent along the inhale and discharge flow paths of the air in the storage chamber in which an air flow occurs by the operation of the cooling air circulating fan. As a result, functions of dewetting and preserving moisture in the storage chamber are performed through the constant humidity agent and simultaneously the smell in the storage chamber can be more positively deodorized with the deodorizing agent.

### BACKGROUND OF THE INVENTION

1. Field of the Invention

The present invention relates to a humidity maintenance and deodorization structure for a Kimchi storage having a cooling air circulating fan in order to store Kimchi which is a Korean traditional fermentation food, and more particularly, to a humidity maintenance and deodorization structure for a Kimchi storage having a cooling air circulating fan, in which air in a storage chamber of the Kimchi Storage is inhaled into the cooling air circulating fan passes through a constant humidity agent and a deodorization agent in the process of circulating the air in the storage room by using the cooling air circulating fan adhered to a door of the Kimchi storage, to thereby uniformly maintain a humidity in the storage room and thus prevent or delay frost from being produced in the storage room, and sustain freshness of food as well as actively deodorize the smell in the storage room.

2. Description of the Related Art

As is well known, a Kimchi storage is a household electric appliance which properly matures Kimchi stored therein, according to change of seasons and tastes of users, and keeps the matured Kimchi at a proper low temperature in custody to thereby maintain taste and freshness of Kimchi on a long-term basis.

Thus, the use of the Kimchi storage appliance (also referred to herein simply as a “Kimchi storage”) has recently gradually increased by housewives having suffered from difficulties in a long-term storage of Kimchi.

General Kimchi storages differ in their structures according to the kinds thereof. However, as shown in FIG. 1, the general Kimchi storage includes a main body 1 having a plurality of storage rooms or chambers 3 and a machine room or chamber (not illustrated) which are arranged along the height direction of the Kimchi storage, and a door 2 which is provided on top of the main body 1, and opens and closes each storage chamber 3.

On the main body or housing 1 is provided a control panel 4 equipped with a plurality of selection buttons for allowing users to select an aging, keeping time, or temperature condition according to the kind of Kimchi accommodated in the storage chamber 3, and a display unit displaying signals selected using the plurality of selection buttons.

In the storage chamber 3 are accommodated a plurality of vessels storing Kimchi, and in the machine chamber (not shown) are provided a compressor, a condenser and a cooling fan, to thus constitute a cooling system together with an evaporator which is wound on the outer circumference of the storage chamber 3.

Moreover, at the lower portion of the evaporator which is wound on the outer side of the storage chamber 3 is provided a heater for aging Kimchi.

After a vessel storing Kimchi is contained in the storage chamber 3 of the Kimchi storage of the above-described structure, the selection buttons on the control panel 4 is operated in order to select a maturing mode or a preservation mode according to the need of a user. Accordingly, Kimchi can be matured and then kept for a long time, or kept without a ripening process for a long term.

But, there is a problem that a temperature difference occurs between the upper and lower portions of the storage room 3, in the process of supplying the cooling air for the conventional storage chamber 3 and maintaining the room temperature of the storage chamber 3 into the temperature which is proper for the Kimchi storage.

Such a problem may be caused by the unsmooth circulation of the cooling air in the tightly closed storage chamber 3.

Accordingly, the cooling air is compulsorily convected between the upper and lower portions of the storage room 3, in order to improve the temperature deflection in the Kimchi storage. As shown in FIG. 1, as a representative example, a cooling air circulating fan 5 is set up in the inside of the door 2, and then the cooling air circulating fan 5 is made to operate, to thus compulsorily circulate the cooling air in the storage chamber 3.

That is, the air in the storage chamber 3 forcibly circulates according to operation of the cooling air circulating fan 5 as described above. The hot air of the upper portion of the storage chamber 3 falls down to the lower portion thereof in this process and the cold air of the lower portion thereof moves up to the upper portion to thereby make the air forcibly convected. Accordingly, the inner temperature of the storage chamber 3 is maintained in a generally uniform state at the upper and lower portions. As a result, Kimchi kept in the storage room 3 can be more effectively uniformly kept at a cooled state.

Moreover, a deodorizing agent receiving portion 6 is provided in the inner surface of the door 2 which is one side of the cooling air circulating fan 5. Here, a deodorizing agent (not illustrated) having the function of deodorizing a smell of Kimchi stored in the storage chamber 3 is usually contained in the deodorizing agent receiving portion 6.

Even in the case of a Kimchi storage which is not equipped with the above-described cooling air circulating fan 5, the deodorizing agent receiving portion 6 is provided in one side of the door 2, and then the deodorizing agent is contained in the deodorizing agent receiving portion 6, so as to have a function of deodorizing a smell of Kimchi stored in the storage room 3. This is a technology generalized in the Kimchi storage field.

In addition, there is a problem that a frost is generated on the inner wall of the storage room 3 according to the temperature deflection or differences in the storage chamber 3 and the moisture distribution in the storage chamber 3 in the process of supplying the cold cooling air of 0° C. or less into the storage chamber 3 of the conventional Kimchi storage and preserving Kimchi on a long term basis.

However, an instrumental unit which can easily remove such frost is not provided in the conventional art. Accordingly, if a predetermined time lapses, a user takes out a Kimchi vessel from the storage chamber 3 and removes frost formed on the wall of the storage room 3 using a manual defrost method. As a result, it is considerably inconvenient and troublesome to defrost the inner wall of the Kimchi storage, and this causes complaints of consumers.

Thus, in order to solve the defrosting problem, various kinds of countermeasures have been recently proposed.

Among them, a hygroscopic agent (not illustrated) is provided in the inner one side of the storage room 3. However, the hygroscopic agent (not illustrated) is provided in a door or in the inner wall or the floor side of the storage room. Thus a frost forming condition can be blocked through the moisture removal function of the hygroscopic agent so that frost is not produced or growth of frost can be delayed at the latest.

However, although the hygroscopic agent performs the function of absorbing the moisture in the storage chamber 3 and thus has an advantage of blocking or delaying production of frost, even the moisture in the chamber created by the food, especially the vegetable or the fruit itself stored in the storage chamber 3, may need to be removed or dehumidified. As a result, there may be a high concern that the hygroscopic agent may be a considerable limiting factor in maintaining the freshness of the food.

Particularly, the conventional cooling air circulating fan 5, the conventional deodorizing agent, and the conventional hygroscopic agent are individually mounted in the Kimchi storage, and thus they have no associative relationship among them. Especially, the deodorizing agent and the hygroscopic agent cannot but passively perform their basic functions at the state where they are contained only in one receiving space.

### SUMMARY OF THE INVENTION

To solve the above problems of Kimchi storages of the conventional art, it is an object of the present invention to provide a humidity maintenance and deodorization structure for a Kimchi storage, which employs a constant humidity agent having a moisture removal function and a moisture supplemental function other than a conventional dehumidifying agent, in which the constant humidity agent and a deodorizing agent are disposed along a flow path of air in the Kimchi storage which is inhaled into the cooling air circulating fan, to then make the air pass through the constant humidity agent and the deodorizing agent more actively.

That is, in the case that there is high humidity in a storage room of a Kimchi storage (not less than an established average value), the present invention performs the moisture removal function through the configuration as described above and blocks or delays the production or the growth of frost. In the case that the moisture is very little and dry in the storage room (not more than the established average value), the moisture of the constant humidity agent is discharged into the chamber room. Accordingly, the present invention performs the moisture preservation function. In this manner, the present invention provides a humidity maintenance and deodorization structure for use in a Kimchi storage having a cooling air circulating fan which uniformly maintains the humidity in the storage room and sustain the freshness of the food.

Further, the deodorizing agent is arranged together with the constant humidity agent along the inhale and discharge flow paths of the air in the storage chamber in which an air flow occurs by the operation of the cooling air circulating fan. As a result, functions of dewetting and preserving moisture in the storage chamber are performed through the constant humidity agent and simultaneously the smell in the storage chamber can be more positively deodorized with the deodorizing agent.

To accomplish the above object of the present invention, there is provided a humidity maintenance and deodorizing structure for use in a Kimchi storage comprising: a cooling air circulating fan which is mounted in a fan mounting portion which is provided on the bottom of a door which opens and closes a storage chamber; and a deodorizing agent receiving portion which receives a deodorizing agent at the side of the fan mounting portion, wherein a flow path which can inhale and discharge air in and from the storage chamber by operation of the cooling air circulating fan in the fan mounting portion is formed between the fan mounting portion and the deodorizing agent receiving portion,
wherein a constant humidity agent is disposed along an inhale flow path of the cooling air circulating fan and moreover a constant humidity agent cover which supports and receives the constant humidity agent is mounted while covering the fan mounting portion,
wherein the deodorizing agent is arranged in the deodorizing agent receiving portion which is a discharge flow path of the cooling air circulating fan, and
wherein a deodorizing agent cover which supports and receives the deodorizing agent is mounted while covering the deodorizing agent receiving portion,
whereby the air in the storage chamber is forcibly circulated by the operation of the cooling air circulating fan in which the air is inhaled toward the constant humidity agent and discharged through the cooling air circulating fan and the deodorizing agent in sequence, while the deodorizing agent is arranged together with the constant humidity agent along the inhale and discharge flow paths of the air in the storage room in which an air flow occurs by the operation of the cooling air circulating fan.

Here, it is preferable that a plurality of air vents are formed in the constant humidity agent cover, the constant humidity agent, the deodorizing agent cover, and the deodorizing agent, so that the air of the storage chamber which is inhaled or discharged can smoothly pass through the plurality of air vents.

Moreover, it is preferable that a flow path guide film is installed on top of the flow path formed between the fan mounting portion and the deodorizing agent receiving portion, to thereby make all discharged air passing through the flow path not be dispersed and discharged but flow into the deodorizing agent receiving portion to then pass through the deodorizing agent and discharged.

### BRIEF DESCRIPTION OF DRAWINGS

The above and other objects and advantages of the present invention will become more apparent by describing the preferred embodiment thereof in more detail with reference to the accompanying drawings in which:

FIG. 1 is a perspective view showing an example of a conventional Kimchi storage storing Kimchi which is a Korean traditional fermentation food in which the Kimchi storage includes a cooling air circulating fan;

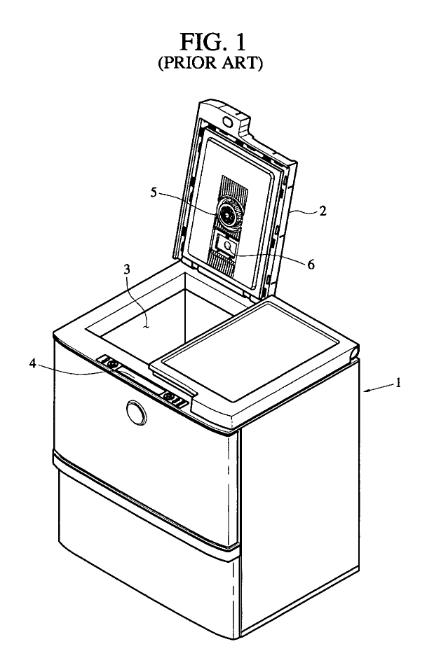

FIG. 2 is a perspective view schematically showing the configuration of a Kimchi storage having a cooling air circulating fan on a door according to the present invention;

FIG. 3 is a disassembled perspective view which shows essential portions of an installation state of a cooling air circulating fan, a constant humidity agent, and a deodorizing agent on a door according to the present invention; and

FIG. 4 is an enlarged view of the bottom of the door which shows an air inhale flow path and an air discharge flow path formed in the door in which a cooling air circulating fan is mounted according to the present invention.

### DETAILED DESCRIPTION OF THE INVENTION

Hereinafter, a humidity maintenance and deodorizing structure for a Kimchi storage according to a preferred embodiment of the present invention will be described with reference to the accompanying drawings.

Here, the present invention relates to a humidity maintenance and deodorizing structure for use in a Kimchi storage having a cooling air circulating fan on a door of a storage chamber in the Kimchi storage. The Kimchi storage to which the present invention is applied has the same configuration as that of the conventional known Kimchi storage except for the compositional elements according to the object which the present invention pursues.

Therefore, hereinafter, the compositional elements in the Kimchi storage according to the present invention will be illustrated with the same names and reference numerals as those of the conventional Kimchi storage, with respect to the portions of the Kimchi storage according to the present invention which employs the same compositional elements as those of the conventional art. Although they have the same titles, respectively different reference numerals will be assigned to the portions having a difference in their shapes and structures between the present invention and the conventional art.

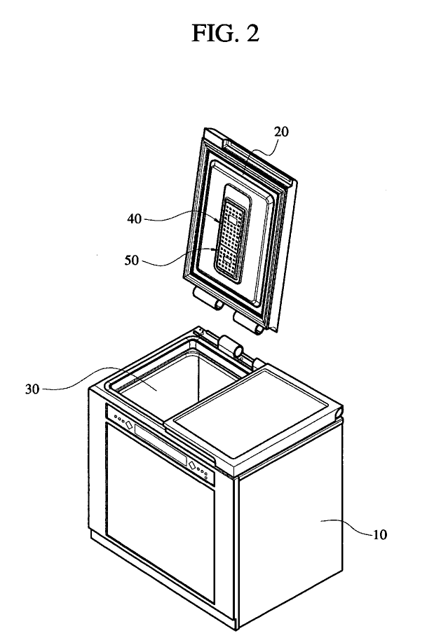

FIG. 2 is a perspective view schematically showing the configuration of a Kimchi storage having a cooling air circulating fan on a door according to the present invention.

Referring to FIG. 2, the Kimchi storage according to the present invention includes a main body 10 in which a plurality of storage chambers 30, which can accommodate and store Kimchi, are formed and a plurality of doors 20 which can open and close the plurality of storage rooms 30, respectively.

Here, in FIG. 2, only a single door 20 is shown for convenience of explanation. The other doors are omitted.

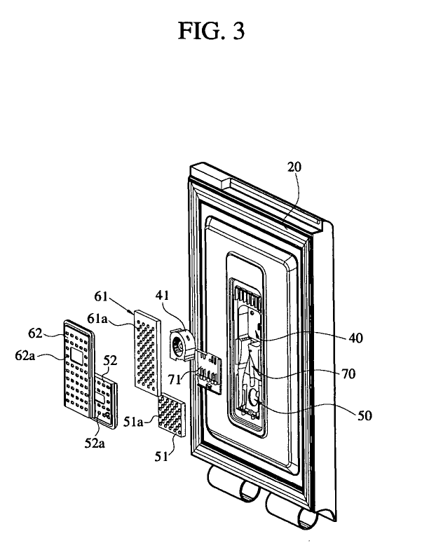

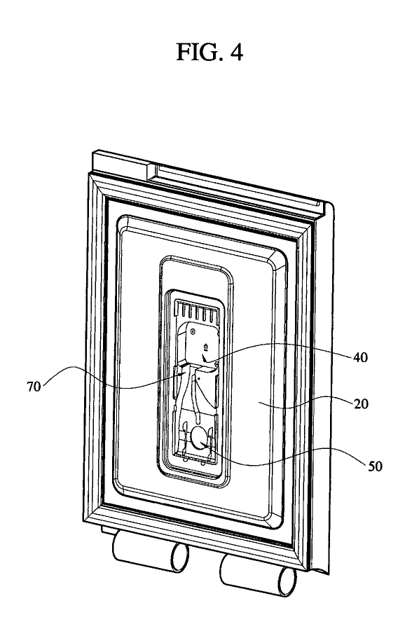

That is, as shown in FIGS. 3 and 4, on the bottom center portion of the door 20 are formed a fan mounting portion or recess 40 for receiving and mounting a cooling air circulating fan 41 inhaling and circulating air in the storage chamber 30 and a deodorizing agent receiving portion or recess 50 receiving a deodorizing agent 51 located at one side of the fan mounting portion 40.

The fan mounting portion 40 and the deodorizing agent receiving portion 50 communicate with each other and are connected through an air flow path 70.

In the present invention, the cooling air circulating fan 41 is of a sirocco fan form and is mounted on the fan mounting portion 40. A constant humidity agent 61 is also provided and has a plurality of air vents 61a. The constant humidity agent 61 is installed on an air inlet or inhalation portion of the cooling air circulating fan 41 through a constant humidity agent cover 62. The deodorizing agent 51 has a plurality of air vents 51a formed in it. The deodorizing agent 51 is installed in the deodorizing agent receiving portion 50 located on the flow path 70 through a deodorizing agent cover 52. Air of drawn into the inlet side of the cooling air circulating fan 41 is discharged through the flow path 70 and deodorizing agent 51.

In more detail, the cooling air circulating fan 41 which is provided on the bottom of the door 20 in the Kimchi storage inhales the air from the storage chamber 30, and then discharges the inhaled air back to the chamber. In this way, the cooling air circulating fan 41 plays a role of compulsorily circulating the air in the storage chamber 30.

Here, it is preferable that the cooling air circulating fan 41 is installed at the center region of the door 20.

As shown in FIGS. 3 and 4, the present invention includes the fan mounting portion 40 formed on the door 20, in order to mount the cooling air circulating fan 41 as described above. The deodorizing agent receiving portion 50 provides a function as the air flow path through which the air is discharged, and the space which can receive the deodorizing agent 51 is provided in association with the fan mounting portion 40. The fan mounting portion 40 and the deodorizing agent receiving portion 50 communicate with each other to thereby form a single flow path 70.

In a structure of a door 20 which is employed in the present invention having a structure that the fan mounting portion 40 and the deodorizing agent receiving portion 50 communicate with each other to thereby form a single flow path 70 as described above, the constant humidity agent 61 is arranged on the flow path in which the cooling air of the storage room 30 is inhaled by the cooling air circulating fan 41 mounted on the fan mounting portion 40.

The constant humidity agent 61 absorbs the moisture from the storage chamber 30 and performs a moisture removal function and a moisture preservation function which provides the storage chamber 30 with moisture, when the humidity of the storage chamber 30 falls down to a predetermined value or less, differently from a hygroscopic agent which is disposed and used in order to absorb the inner moisture of the conventional storage chamber 30, and perform only the moisture removal. As a result, the present invention can always maintain the humidity of the storage chamber 30 into a predetermined level in which a constant humidity rate is approximately 60-70%.

The constant humidity agent 61 performing the above-described function is made of a ceramic plastic body. The constant humidity agent 61 applied to the present invention is made of Modenite A of 43 w %, Modenite B of 47 w %, Wt-Al of 3 w %, sericite whose grain size is 13 μm of 5 w %, and 80 mesh yellow soil whose grain size is 173 μm of 2 w %. The principal ingredients include SiO₂, A1₂0₃, Fe₂O₃, CaO, MgO, K₂0, and Na₂O.

The constant humidity agent 61 having the configuration as described above has not only the moisture removal function but also may have a deodorization function. By experiment, the constant humidity agent 61 deodorizes 95% of smell elements such as H₂S and CH₃SH in about 2 hours in a closed space.

The constant humidity agent 61 can be detachably mounted on the bottom of the door 20 through the constant humidity agent cover 62. The constant humidity agent cover 62 covers the fan mounting portion 40 in whole.

Particularly, it has been described the constant humidity agent cover 62 is detachably mounted on the bottom surface of the door 20. However, it may be acceptable that the constant humidity agent cover 62 is fixedly installed so that it is not actually easily separated from the door 20.

Since the constant humidity agent 61 which is received and mounted by the constant humidity agent cover 62 can be semi-perpetually used, and thus once it is mounted in the constant humidity agent cover 62, there is not nearly need to replace it. Accordingly, it may be acceptable that it is difficult to separate the constant humidity agent 61 from the constant humidity agent cover 62, since the constant humidity agent cover 62 can be adamantly fixed.

But, it is preferable that the constant humidity agent cover 62 is equipped with a detachable structure in preparation for the case that the constant humidity agent cover 62 needs to be inevitably separated due to malfunction of the cooling air circulating fan 41 mounted on the bottom of the constant humidity agent 61.

Particularly, in the constant humidity agent cover 62 and the constant humidity agent 61 themselves are formed a plurality of air vents 61a and 62a, and thus when the cooling air is inhaled by operation of the cooling air circulating fan 41, the cooling air is inhaled to pass through the air vents 61a and 62a.

Thus, the air vents 61a and 62a play a role of an inhalation passage for smooth suction of the cooling air.

In this manner, the constant humidity agent 61 absorbs the moisture to thus perform a moisture removal function in the process of inhaling the cooling air through the air vents 61 a formed in the constant humidity agent 61 by operation of the cooling air circulating fan 41.

Of course, in the case that the moisture content in the storage chamber 30 is less and thus the humidity rate in the storage room 30 does not maintain 60-70%, moisture is supplied from the constant humidity agent 61 and discharged to the storage room 30 in the process where the cooling air passes through the constant humidity agent 61. Accordingly, the humidity rate in the storage room 30 can maintain about 60-70%.

As described above, the present invention is provided with the deodorizing agent receiving portion 50 at the side of the flow path in which the air of the cooling air circulating fan 41 is discharged. Here, the deodorizing agent 20 is received and mounted in the deodorizing agent receiving portion 50. In that way, the deodorizing agent 20 can deodorize the smell effectively and actively while the air discharged via the constant humidity agent 61 and the cooling air circulating fan 41 passes through the deodorizing agent 51 once more.

That is, the constant humidity agent 61 itself has a deodorization function to some extent, but has a slightly insufficient defect in view of the completeness of the deodorization function. Therefore, a dedicated deodorizing agent 51 is used to effectively remove various kinds of smell components, to thereby maximize the deodorization efficiency.

Here, the deodorizing agent 51 can be made of at least any one material selected from the group consisting of active carbon, active white earth, silicagel, negative ion stone, ceramic, yellow earth, and charcoal. Besides, the widely known, customarily used and the generalized and various kinds of the deodorizing agents can be employed in the present invention.

The deodorizing agent 51 is a consumable. Accordingly, if it is determined that the deodorization capacity is lowered, it is preferable that a user can easily replace the deodorizing agent 51.

For this purpose, the deodorizing agent 51 is installed in the deodorizing agent receiving portion 50 through the deodorizing agent cover 52. In this case, the deodorizing agent cover 52 is detachably engaged with the bottom surface of the door 20.

Here, the deodorizing agent cover 52 covers the deodorizing agent receiving portion 50 at the bottom of the door 20, and allows the deodorizing agent 51 to be detachably mounted therein. Although they are not illustrated in detail, one who has an ordinary skill in the art and who can understand the present invention can implement the deodorizing agent cover 52 covering the deodorizing agent receiving portion 50 at the bottom of the door 20, in various forms. Thus, the detailed description thereof will be omitted.

For example, the deodorizing agent cover 52 can be detachably mounted on the bottom surface of the door 20 in a simple and facilitating structure through screw engagement or fitting assembly through a hook type. Since the above-described deodorizing agent cover mounting technology is very generalized known, it is apparent that the deodorizing agent cover can be realized in various forms although the detailed description thereof is not described.

Preferably, the deodorizing agent 51 and the deodorizing agent cover 52 are equipped with a number of air vents 51a and 52a, so that the discharged air via the cooling air circulating fan 41 can be again smoothly supplied to the storage chamber 30.

Here, according to the preferred embodiment of the present invention, the constant humidity agent cover 62 and the deodorizing agent cover 52 cover the fan mounting portion 40 and the deodorizing agent receiving portion 50, respectively on the bottom surface of the door 20 and are separated from each other and respectively connected and assembled. However, the present invention is not limited thereto.

As described above, the constant humidity agent 61 is semi-perpetually used. Once the constant humidity agent cover 62 has been assembled with the bottom of the door 20, it is fixed so as not to be disassembled therefrom. However, since the deodorizing agent 51 is a consumable and need to be replaced by new one if the deodorization function becomes low, the deodorizing agent cover 52 is fabricated so that it can be easily separated as necessary. Accordingly, the deodorizing agent cover 52 has been described as a separable assembly. However, although the constant humidity agent cover 62 and the deodorizing agent cover 52 are integrally fabricated and assembled, there is no problem of playing a role of performing respective functions thereof.

The constant humidity agent cover 62 and the deodorizing agent cover 52 play a role of fixing the constant humidity agent 61 and the deodorizing agent 51 so that they do not break away from respective positions thereof, and simultaneously protecting the constant humidity agent 61 and the deodorizing agent 51 from being externally exposed. Therefore, the constant humidity agent cover 62 and the deodorizing agent cover 52 can be integrally manufactured.

A flow path guide film 71 blocking the top of the flow path 70 in the flow path 70 associated with the deodorizing agent receiving portion 50 in which the deodorizing agent 51 is accommodated is provided in the preferred embodiment of the present invention. Accordingly, the flow path guide film 71 plays a role of a guide so that the discharged air passing through the flow path 70 is not being dispersedly discharged, and certainly flows into the deodorizing agent receiving portion 50 to then be discharged via the deodorizing agent 51.

Here, the flow path guide film 71 makes all the discharged air which passes through the constant humidity agent 61 and the cooling air circulating fan 41 by the operation of the cooling air circulating fan 41 pass through the deodorizing agent 51. That is, the flow path guide film 71 is provided to enhance a deodorization efficiency to be higher.

Therefore, with a configuration as described above, all the air guided and discharged by the flow path guide film 71 passes through the deodorizing agent 51, at the position in which the air which compulsorily flows by the cooling air circulating fan 41 is discharged. As a result, smell of food and drink in the storage chamber 30 can be very deodorized very effectively and actively.

As illustrated above, the deodorizing agent is arranged together with the constant humidity agent along the inhale and discharge flow paths of the air in the storage chamber in which an air flow occurs by the operation of the cooling air circulating fan. As a result, functions of dewetting and preserving moisture in the storage chamber are performed through the constant humidity agent and simultaneously the smell in the storage room can be more positively deodorized with the deodorizing agent.

In particular, in the case that there are high humidity in a storage chamber of a Kimchi storage (not less than an established average value), the present invention performs the moisture removal function through the configuration as described above and blocks or delays the production or the growth of frost. In the case that the moisture is very little and dry in the storage chamber (not more than the established average value), the moisture of the constant humidity agent is discharged into the storage chamber. Accordingly, the present invention performs the moisture preservation function. In this manner, the present invention provides a humidity maintenance and deodorization structure for use in a Kimchi storage having a cooling air circulating fan which uniformly maintains the humidity in the storage chamber and sustains the freshness of the food.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

What is claimed is:

1. In Kimchi storage having at least one storage chamber formed therein and a door for opening and closing the chamber, a humidity maintenance and deodorizing apparatus comprising:
a cooling air circulating fan mounted in a fan mounting portion provided on the bottom of the door facing the chamber when closed;
a deodorizing agent receiving portion formed in said door bottom adjacent said fan mounting portion for receiving, a deodorizing agent;
a flow path formed in said door bottom portion between the fan mounting portion and the deodorizing agent receiving portion; and
a constant humidity agent disposed along the air inlet of the cooling air circulating fan and a constant humidity agent cover for supporting and receiving the constant humidity agent and mounted to cover the fan mounting portion, said deodorizing agent being located in the deodorizing agent receiving portion which is located at the discharge end of said flow path from the cooling air circulating fan; and
a deodorizing agent cover for supporting and receiving the deodorizing agent mounted to cover the deodorizing agent receiving portion,
whereby the air in the storage chamber is forcibly circulated by the operation of the cooling air circulating fan in which the air is inhaled toward the constant humidity agent and discharged through the cooling air circulating fan and the deodorizing agent in sequence, while the deodorizing agent is arranged together with the constant humidity agent along the inlet and discharge flow paths of the air in the storage chamber in which an air flow occurs by the operation of the cooling air circulating fan.

2. A Kimchi storage as defined in claim 1, wherein a plurality of air vents are formed in the constant humidity agent cover, the constant humidity agent, the deodorizing agent cover, and the deodorizing agent, so that the air of the storage chamber which is inhaled or discharged can smoothly pass through the plurality of air vents.

3. A Kimchi storage as defined in claim 1 or 2, wherein a flow path guide film is installed on top of the flow path formed between the fan mounting portion and the deodorizing agent receiving portion, to thereby make all discharged air passing through the flow path not be dispersed and discharged but flow into the deodorizing agent receiving portion to then pass through the deodorizing agent and discharged.
